(19) United States
(12) Patent Application Publication
(10) Pub. No.: US 2002/0118401 A1
(43) Pub. Date: Aug. 29, 2002

(54) Dynamically focusing method for image scanning device

(76) Inventor: Chui-Kuei Chiu, Hsinchu Hsian (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/793,622

(22) Filed: Feb. 27, 2001

(51) Int. Cl. H04N 1/04

(52) U.S. Cl. 358/474

(57) ABSTRACT

A dynamically focusing method for an image scanning device is disclosed. Prior to a formal scanning of the image scanning device, a series of pre-scan processes are performed to obtain a set of optimal focus data of the document to be scanned. The pre-scan processes include steps of selecting a focusing reference surface and a preset focusing interval of the document, and moving the optic scanning module in a first direction to pre-scan the document. A focus-adjusting driving mechanism drives the optic scanning module to move in a second direction with respect to the focusing reference surface during the scanning of the optic scanning module, based on the preset focusing interval, to obtain a set of optimal focus data of the document. The optimal focus data obtained is further stored in a memory. In formal scanning, the image scanning device scans the document based on the optimal focus data by moving the optic scanning module in the first direction and simultaneously driving the optic scanning module to move in the second direction according to the optimal focus data.

### BACKGROUND OF THE INVENTION

1. Field of the Invention

The present invention relates to a focusing method for an image scanning device, and in particular to a focusing method for dynamically focusing a document to be scanned located on the document positioning plate of an image scanning device during scanning. The focusing method includes a series of pre-scan processes, prior to a formal scanning of the image scanning device, to obtain a set of optimal focus data of the document.

2. Description of the Prior Art

Scanners have been widely utilized in scanning images to allow retrieving and saving. Due to improvements in the scanning technology and the demands for scanning high quality images, the scanning resolution of the scanner becomes higher and higher. Therefore, the subject matter of focusing during scanning operation is an important issue.

FIG. 1 of the attached drawings shows an example of a conventional flatbed optic scanner, mainly comprising a casing 1, a top plate 11, a light transmittable document positioning plate 12, a cover 13, an optic scanning module 14, and a pair of guide rods 15a, 15b. The document positioning plate 12 is generally made of glass or other light transmittable material for supporting a document to be scanned (not shown), defining a document scanning widow of the scanner. The cover 13 is pivotally mounted on a lateral side of the casing 1, serving as a light masking plate.

The guide rods 15a, 15b are parallel to and spaced from each other. The optic scanning module 14 may be moved along the guide rods 15a, 15b by a driving mechanism (not shown). The driving mechanism generally includes a driving motor and a transmission belt or a gear train mechanically coupled to the optic scanning module.

Referring to FIG. 2, it is a schematic view showing the light path of the conventional scanning device of FIG. 1. The optic scanning module 14 is provided with a light source 16, a plurality of reflective mirrors 171, 172, 173, 174, a focusing lens 18, and an image sensing module 19 such as a Charge Coupling Device (CCD).

Ideally, the document 2 placed on the document positioning plate 12 should be even. Thus, the conventional scanner is mostly designed to have a fixed focus operation mode. However, if the document 2 is uneven, for instance, the center region of the document 2 is dented or bent or tilted, the image obtained from scanning is unclear or inconsistent.

FIGS. 3 through 5 show various situations that may cause unclear or inconsistent scanning image. FIG. 3 is a schematic view showing a document 2 to be scanned is placed on the document positioning plate 12 of the conventional image scanning device, and the center region of the document 2 is dented. FIG. 4 shows the document 2 placed on the document positioning plate 12 of the conventional scanning device is tilted. FIG. 5 shows the document 2 placed on the document positioning plate 12 of the conventional scanning device is not even. These situations, in the process of scanning operation, cause inaccurate focusing which produces unclear images.

In the process of scanning operation, in some occasion, an auxiliary film clip can be used to clip the document to be scanned and then proceed to image scanning. However, in the occasion where the auxiliary film clip is used, the evenness and the thickness of the film clip will affect the optimal focusing operation of the scanner and thereby effect the scanning quality.

In the future, the demand for high scanning resolution is higher and higher. In order to get a better image quality, the scanner is preferably provided with an automatic focusing function. However, most of the conventional scanners are designed to have fixed focusing function.

In addition, as the image scanner utilizes a linear image sensing element, the optic scanning module of the scanner is required to move smoothly and correspondingly with respect to the entire region of the document to be scanned during scanning. Otherwise, the scanned image will become blur at certain region of the document.

It is thus desirable to provide a dynamically focusing method for the image scanning device to overcome the above problems.

### SUMMARY OF THE INVENTION

The primary object of the present invention is to provide a focusing method for dynamically focusing a document to be scanned during scanning of an image scanning device, capable of effectively overcoming the problems of the prior art.

It is still another object of the present invention to provide a dynamically focusing method for an image scanning device. The focusing method includes a series of pre-scan processes to obtain a set of optimal focus data of the document. In formal scanning, the image scanning device scans the document based on the optimal focus data by moving the optic scanning module and simultaneously driving the optic scanning module to move according to the optimal focus data.

It is another object of the present invention to provide a focusing method for an image scanning device provided with an optimal focusing data memory for storing at least one set of optimal focusing data therein.

To achieve the above objects, in accordance with a preferable embodiment of the present invention, there is provided a dynamically focusing method for an image scanning device. Prior to a formal scanning of the image scanning device, a series of pre-scan processes are performed to obtain a set of optimal focus data of the document to be scanned. The pre-scan processes include steps of selecting a focusing reference surface and a preset focusing interval of the document, and moving the optic scanning module in a first direction to pre-scan the document. A focus-adjusting driving mechanism drives the optic scanning module to move in a second direction with respect to the focusing reference surface during the scanning of the optic scanning module, based on the preset focusing interval, to obtain a set of optimal focus data of the document. In formal scanning, the image scanning device scans the document based on the optimal focus data by moving the optic scanning module in the first direction and simultaneously driving the optic scanning module to move in the second direction according to the optimal focus data. Preferably, the optimal focus data obtained is further stored in an optimal focus data memory.

### BRIEF DESCRIPTION OF THE DRAWINGS

The present invention will be apparent to those skilled in the art by reading the following description of preferred embodiments thereof, with reference to the attached drawings, in which:

FIG. 1 is a perspective view of a conventional flat-bed image scanning device;

FIG. 2 is a schematic view showing the light path of the conventional image scanning device of FIG. 1;

FIG. 3 is a schematic view showing a document to be scanned is placed on a document positioning plate of a conventional scanner, and the center region of the document is dented;

FIG. 4 is a schematic view showing a document to be scanned is placed on a document positioning plate of a conventional scanner, and the document is tilted;

FIG. 5 is a schematic view showing a document to be scanned is placed on a document positioning plate of a conventional scanner, and the center region of the document is not even;

FIG. 6 is a schematic view showing the light path of the scanning device of the present invention;

FIG. 7 is a schematic view showing a number of preset focusing intervals are set with respect to the document in accordance with the present invention; and

FIG. 8 is a control flowchart of the present invention.

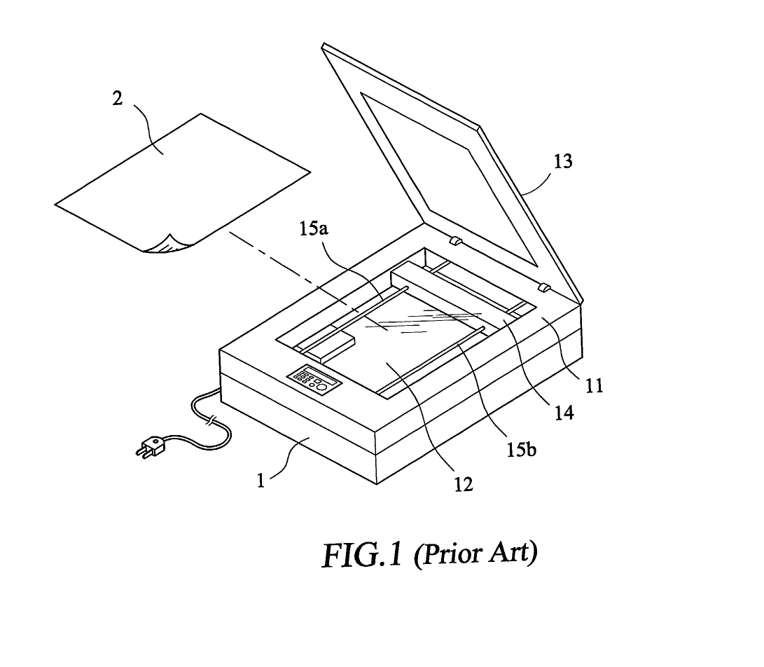

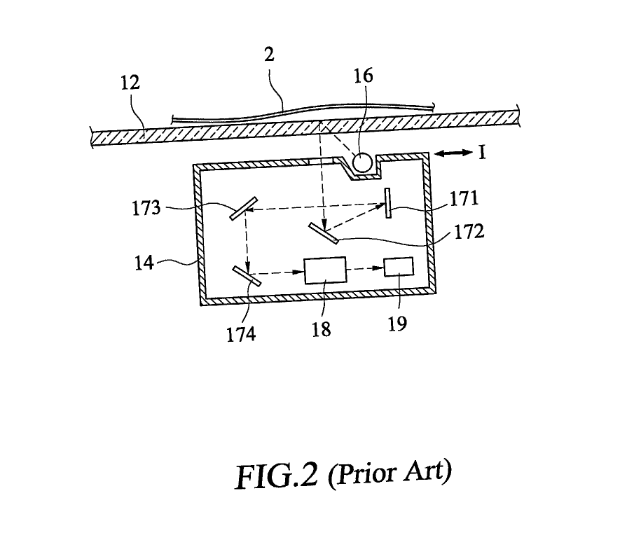

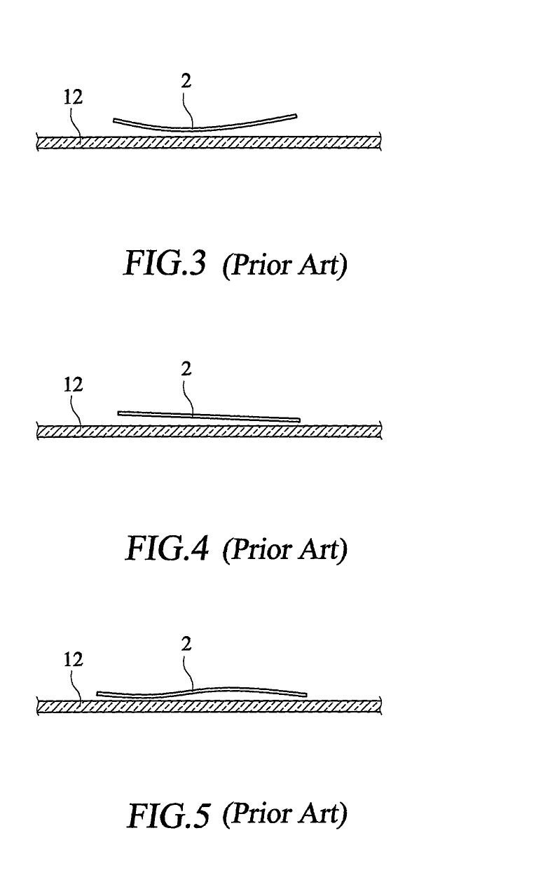

### DETAILED DESCRIPTION OF THE PREFERRED EMBODIMENTS

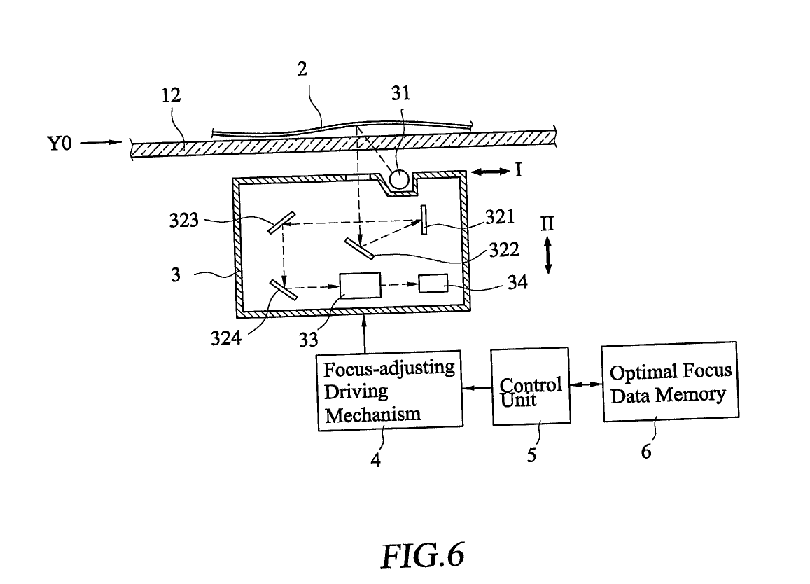

With reference to FIG. 6, it is a schematic view showing a light path of a reflective type image scanning device in accordance with the present invention. The same reference numbers used in the previous drawing will be used to refer to the same or like parts.

A document 2 to be scanned is placed on a document positioning plate 12 of an image scanning device. An optic scanning module 3 is arranged beneath the document positioning plate 12, which is equipped with a light source 31, a plurality of reflective mirrors 321, 322, 323, 324, a focusing lens 33, and an image sensing module 34. The optic scanning module 3 may be moved by a known driving mechanism (not shown) in a first direction I under control of a control circuit to scan the document 2 placed on the document positioning plate 12. The first direction I is substantially parallel to the focusing reference surface Y0.

In accordance with a preferred embodiment of the present invention, the optic scanning module 3 can be driven by a focus-adjusting driving mechanism 4 under control of a control unit 5. So, the optic scanning module 3 can move with respect to the document positioning plate 12 in a second direction II (i.e., up-down direction) to dynamically focus a focusing reference surface Y0. In a preferable embodiment of the present invention, the bottom surface of the document 2 serves as the focusing reference surface. The second direction II is substantially perpendicular to the focusing reference surface Y0.

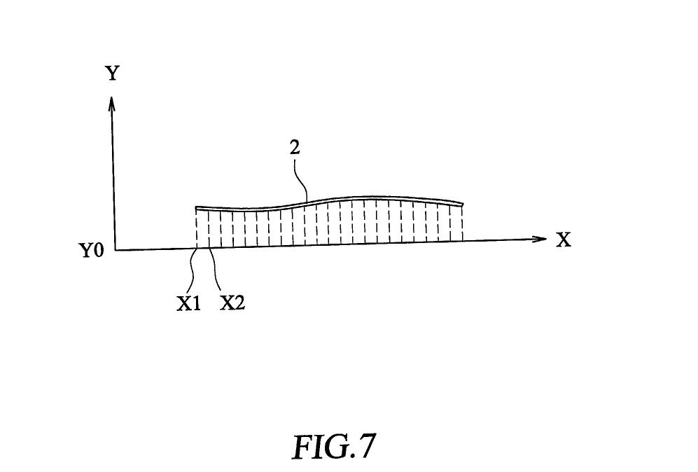

Prior to a formal scanning operation of the scanner, the scanner can perform a pre-scanning procedure for obtaining an optimal focusing data of the document 2 to be scanned. In the pre-scanning procedure, the optic sensing module 3 is moved in the first direction I, based on a preset focusing interval, i.e., the distance from X1 to X2 of FIG. 7. At the same time, the optic sensing module 3 is driven by the focus-adjusting driving mechanism 4 to move in the second direction II with respect to the focusing reference surface Y0.

Accordingly, for the entire region or a partial region of the document 2, a set or multiple sets of optimal focusing data may be obtained. Further, the optimal focusing data may be saved in an optimal focusing data memory 6, constituting an optimal focusing database.

Thus, in the process of formal scanning operation of the scanner, the optimal focusing data may be used as a basis for dynamically focusing operation. That is, the focus-adjusting driving mechanism 4 is capable of moving the optic scanning module 3 with respect to the document 2, based on the optimal focusing data.

Preferably, in accordance with the present invention, multiple sets of optimal focus data with different parameters are stored in the optimal focus data memory 6 for selection.

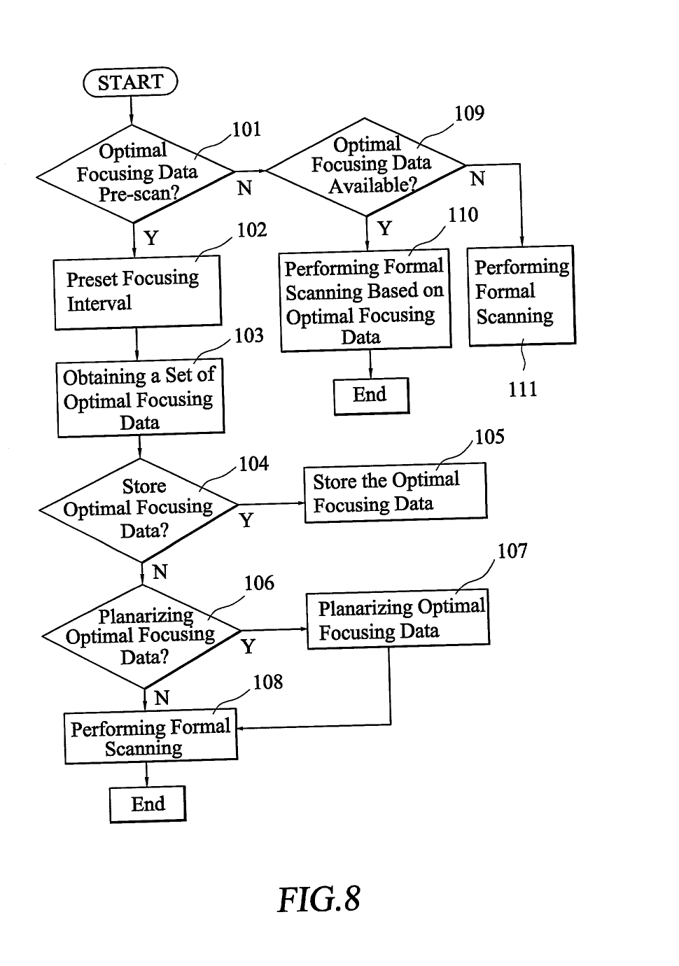

With reference to FIGS. 6, 7 and 8, the dynamically focusing method of the present invention will be described in more detail below. Initially, prior to a formal scanning operation of the scanner, the user can select whether or not an optimal focusing data pre-scanning procedure is performed in step 101. The user also can select a partial region or entire region of the document 2 is to be scanned in this step. If YES, the user can further set a preset focusing interval (i.e., the distance between X1 and X2 of FIG. 7) in step 102. Thereafter, the optic scanning module 3 of the scanner scans the document 2 in step 103 according to the preset parameters of steps 101 and 102 to obtain a set of optimal focusing data.

In step 104, the user can decide whether or not the obtained optimal focusing data should be saved in the optimal focusing data memory 6 of FIG. 6. If YES, the focusing data is stored in the optimal focusing data memory as a database in step 105. If NO, the use can select whether the optimal focusing data should be planarized in step 107. If YES, planarizing processes are performed to optimize the focusing data. After the pre-scanning processes described above, the optic scanning module of the scanner proceeds with a formal scanning procedure operated in dynamically focusing operation mode in step 108, based on the optimal focusing data obtained in Step 103, so as to obtain an optimal scanned image quality.

In the above step 101, if the user selects the pre-scanning procedure is not required, the user can further select whether a set of optimal focusing data is pre-stored in the focusing data memory in step 109. If YES, the optic scanning module of the scanner proceeds with a formal scanning procedure operated in dynamically focusing operation mode in step 110, based on the optimal focusing data pre-stored in the focusing data memory.

In step 109, if the focusing data memory of the scanner does not store any focusing data for scanning operation, the scanner proceeds to execute general scanning operation in step 111, i.e., dynamically focusing function is not executable.

In accordance with the preferred embodiment of the present invention, the optic scanning module of the scanner operated in dynamically focusing operation mode may be driven to move up or down with respect to the uneven document to be scanned, thereby obtaining a high scanned image quality. To those skilled in this art, it is to be understood that a variety of modifications may be made to achieve the same dynamical focusing function, such as moving the document positioning plate 12 of FIG. 6 with respect to the optic sensing module 3, moving the optic sensing module 3 with respect to the document positioning plate 12, or moving the image sensing element 34 with respect to the focusing lens 33.

Although the present invention has been described with reference to the preferred embodiments thereof, it is apparent to those skilled in the art that a variety of modifications and changes may be made without departing from the scope of the present invention which is intended to be defined by the appended claims.

1. A focusing method for dynamically focusing a document located on a document positioning plate of an image scanning device by moving an optic scanning module of the image scanning device with respect to the document, comprising the following steps:
(a) selecting a focusing reference surface and a preset focusing interval of the document;
(b) moving the optic scanning module in a first direction parallel to the focusing reference surface to pre-scan the document;
(c) driving the optic scanning module in a second direction perpendicular to the focusing reference surface during the scanning of the optic scanning module, based on the preset focusing interval, to obtain a set of optimal focus data of the document; and
(d) scanning the document based on the optimal focus data by moving the optic scanning module in the first direction and simultaneously driving the optic scanning module to move in the second direction according to the optimal focus data.

2. The focusing method as claimed in claim 1, wherein the document positioning plate of the image scanning device serves as the focusing reference surface.

3. The focusing method as claimed in claim 1, further comprising a step of storing the optimal focus data in an optimal focus data memory in step (c).

4. The focusing method as claimed in claim 3, wherein the optimal focus data memory comprises multiple sets of optimal focus data therein.
